(19) United States
(12) Patent Application Publication
(10) Pub. No.: US 2010/0092364 A1
(43) Pub. Date: Apr. 15, 2010

(54) Surface Functionalized Colloidally Stable Spheroidal Nano-apatites Exhibiting Intrinsic Multi-functionality

(76) Inventors: Rajendra Kumar Kasinath, Butte, MT (US); Kumar Ganesan, Butte, MT (US); Marisa Pedulla, Butte, MT (US)

Correspondence Address: JEAN KYLE, P. O. BOX 2274, HAMILTON, MT, 59840-4274, US

(21) Appl. No.: 12/578,537

(22) Filed: Oct. 13, 2009

Related U.S. Application Data
(60) Provisional application No. 61/104,652, filed on Oct. 10, 2008.

(51) Int. Cl. C01F 17/00; C01B 25/26

(52) U.S. Cl. 423/263; 423/306

(57) ABSTRACT

Calcium-phosphate based nanoparticles (CAPNP) are synthesized which are simultaneously intrinsically magnetic and fluorescent, and extrinsically surface modified to serve an attachment function. Doping calcium phosphates during colloidal synthesis results in 10 nm particles that are stable in aqueous media and at physiological pH. The scalable, one-step synthesis produces several modified CAPNPs. By introducing metal dopants into the base crystal lattice during synthesis, magnetically, electronically and optically enhanced nanoparticle dispersions were similarly synthesized.

### CROSS-REFERENCE TO RELATED APPLICATIONS

This application claims the benefits of U.S. Provisional Application No. 61/104,652 filed Oct. 10, 2008, the disclosure of which is hereby incorporated by reference in its entirety including all figures, tables and drawings.

### STATEMENT REGARDING FEDERALLY SPONSORED RESEARCH OR DEVELOPMENT

This invention was made in part with Government support under Grant No. B28026 awarded by the National Science Foundation. The government has certain rights in the invention.

### REFERENCE TO SEQUENCE LISTING, A TABLE, OR COMPUTER PROGRAM LISTING COMPACT DISC APPENDIX

Not Applicable

### BACKGROUND OF THE INVENTION

Rudimentary bio-molecules such as proteins and polysaccharides, which usually have nanometer dimensions, achieve several levels of functionality in biological processes. Particles with nanometric dimensions (5-50 nm) therefore should be able to probe cellular phenomena, such as cellular trafficking. Nanoparticles intended for use in biology are generally classified as nano-biomaterials. At present, the ability to produce un-agglomerated individualized nanoparticles below 50 nm is a daunting task. A critical factor determining final aggregation of nanoparticles is stabilization of the particle at a particular pH range (generally physiological, pH 7.4) in the media of interest. Since particles smaller than 50 nm possess extremely high surface area (hence surface energy) colloidal stability remains a problem. This high surface energy leads to an “energy-driven,” uncontrolled aggregation which is highly unfavorable. As the fraction of atoms on the surface of a spherical particle, roughly 10 nm, becomes approximately 50% of the total, control over aggregation becomes even more critical. Organic molecules, adsorbed or chemisorbed on the surface of the nanoparticle can be used to control size. These absorbed molecules can further serve as linkers, facilitating the binding of various biocompatible moieties depending on the function required by a specific application (see, for example, Lebugle et al., 2006, Yang, et al., 2008, and Aissa, et al., 2009). Functional nano-biomaterials, in addition to being an appropriate size and displaying minimal toxicity should also posses certain qualities to effectively be used for biological applications. These qualities are:
(1) The potential for interaction between the nanoparticle and its intended target. This is typically achieved through surface modifications that would illicit binding (for example, an antibody, or cell-receptor complements attached via a linker or a monolayer of small molecules),
(2) Easy particle tracking and detection. This implies the particle needs to exhibit fluorescent behavior (excitation and emission ideally being in visual range) or the ability to detectably change optical properties easily, and
(3) Easy manipulation, for example, “magnetic” nanoparticles that can be guided to the target with the use of an external magnetic field. This also suggests that the nanoparticles should ideally exhibit super-paramagnetic properties, characterized by high magnetic saturation and minimal or no remenance compared to ferromagnetic materials.

The combination of these characteristics coupled with suitable particle size tuned for the application make nanoparticles highly versatile for a large number of biological and other applications. Ideally, the combination of selectivity and tuned luminescent and magnetic properties results in the simultaneous ability to detect, target, and manipulate nanoparticles.

All patents, patent applications, provisional patent applications and publications referred to or cited herein, are incorporated by reference in their entirety to the extent they are not inconsistent with the teachings of the specification.

### BRIEF SUMMARY OF THE INVENTION

The invention involves the synthesis of calcium-phosphate based nanoparticles (CAPNP) which are simultaneously intrinsically magnetic and fluorescent, and extrinsically surface modified to serve an attachment function. This is achieved by doping calcium phosphates during colloidal synthesis resulting in 10 nm particles that are stable in aqueous media and importantly at physiological pH. The synthesis is simple (with a high potential for scale up and production) and enables in one step the production of several modified CAPNPs. These magnetically, electronically and optically enhanced nanoparticle dispersions are synthesized similarly by introducing metal dopants into the base crystal lattice during synthesis. The biologically benign and chemically stable nature of this material make these nanoparticles ideal candidates for controlled biomedical imaging and biochemical sensing, and as cellular delivery vehicles. Coupled with this is the fact that surfaces of these particles can be conveniently functionalized and can be linked to a host of other agents (molecules) to achieve several other levels of functionality, such as self-assembly, cellular and tissue specificity and prolonged turn over time in vivo.

### BRIEF DESCRIPTION OF THE SEVERAL VIEWS OF THE DRAWINGS

FIG. 1A is an electron micrograph showing the size and shape of a preferred embodiment of the nanoparticles of the subject invention.

FIG. 1B is a photograph of a preferred embodiment of the nanoparticles of the subject invention as a precipitate in a tube and dispersed within the same tube.

FIG. 2 shows variation of the subject nanoparticles in their absorbance profiles.

FIGS. 3A-D are scanning electron micrographs showing the evolution of a preferred embodiment of an (a) amorphous calcium-phosphate gel into more defined structures starting at (b) 6 hours, at (c) 1 day, and at (d) 3 days into equiaxed individual nanoparticles roughly 10 nm.

FIG. 4 shows the evolution of apatite structure, from the start of synthesis (0 hr) up to 3 days when nanoparticles with the apatite structure are formed, via X-ray diffraction (FIG. 4A) and Fourier transformed infra-red spectroscopy (FIG. 4B).

FIG. 5A and FIG. 5B are photographs showing a preferred embodiment of Fe-doped HA nanoparticles assembled over high-field magnets.

FIG. 6A and FIG. 6B are photographs showing a preferred embodiment of Fe-doped hydroxyapatite (HA) nanoparticles exhibiting green luminescence when excited with UV radiation.

FIG. 7 is a photograph showing the interaction between bacteria, a preferred embodiment of nano-apatite particles, and bacteriophages.

The patent or application file contains at least one drawing executed in color. Copies of this patent or patent application publication with color drawing(s) will be provided by the U.S. Patent and Trademark Office upon request and payment of the necessary fee.

### DETAILED DESCRIPTION OF THE INVENTION

Colloidally stable apatite nanoparticles (10-20 nm) with the intrinsic ability to exhibit fluorescent and super-paramagnetic properties simultaneously possess the potential for interaction, are easy to track and detect, are easily manipulated, and are versatile tools for many applications.

Generally, the nanoparticles of the subject invention are synthesized by equilibrating a calcium ion source, or salt thereof. An appropriate calcium ion chelator is added to the equilibrated solution. An appropriate chelator is one that chelates Ca²⁺ ions such that the free energy reduction associated with the chelation does not exceed the free energy reduction associated with the formation of the apatite phase. Finally, a phosphate source is added to begin nanoparticle formation. Molar concentrations of calcium to phosphate should be about 10:6. The pH of the calcium phosphate solution is adjusted to from about 8.0 to about 9.0 and an amorphous calcium phosphate precursor gel is formed. As the gel ages calcium hydroxyl-carbonated apatite nanoparticles are formed. An effective amount of a metal ion is added to the base crystal lattice during formation to impart magnetic and luminescent properties to the nanoparticles. In a particularly preferred embodiment, iron is added during synthesis at about 5 molar to about 40 molar percent. In another preferred embodiment, neodymium is added to the nanoparticles during synthesis at about 5 molar to about 30 molar percent.

The following examples are offered to further illustrate but not limit both the compositions and the methods of the present invention. All percentages are by weight and all solvent mixture proportions are by volume unless otherwise noted.

### Example 1

### General Synthesis

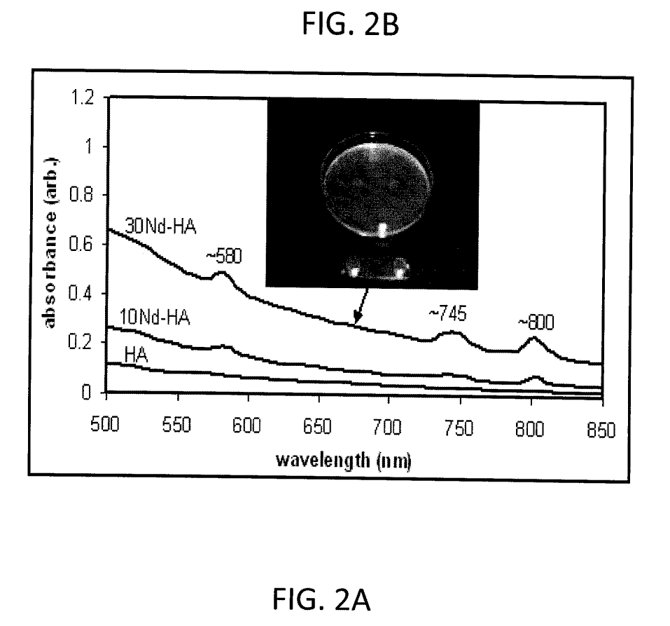

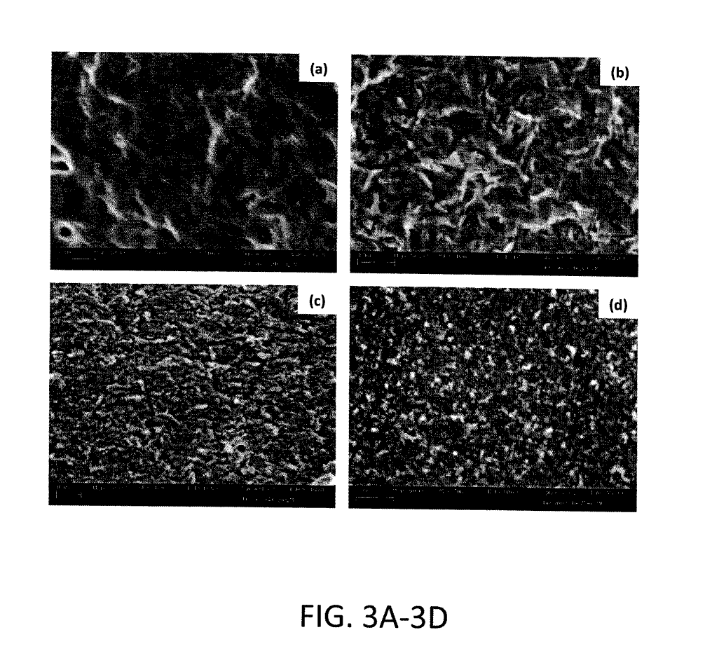

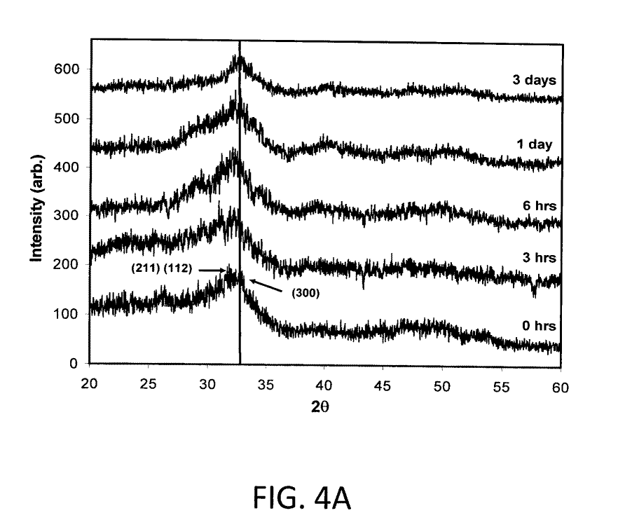

A preferred embodiment of the nanoparticles of the subject invention are synthesized as follows:
(1) 10 mM of Ca(OH)² is stirred and equilibrated at 40° C. in 200 ml for 15 minutes.
(2) Subsequently, a calcium ion chelator (citric acid), specifically 2.0-3.3 mmoles is added to the solution in (1).
(3) Lastly, 50 ml containing 6 mmoles of a phosphate (PO₄³⁻) source (KH₂PO₄) is added drop wise to achieve a final volume of 250 ml.
(4) At this time point the pH is about 8.5 and an amorphous calcium phosphate precursor gel is formed, which is then aged typically for 3 days before the final product is formed. (FIGS. 2A-2D show the morphological evolution of the particles under SEM), (FIGS. 3A and 3B show the evolution of apatite structure via X-ray diffraction and Fourier transformed infra-red spectroscopy, respectively).
(5) The final product is a dispersion of nanoparticulate calcium hydroxyl-carbonated apatite in the 10 nm size range, which is clear to the naked eye.

### Example 2

### Synthesis of Metal Doped Nanoparticles

A preferred embodiment of the metal doped apatite nanoparticles of the subject invention are synthesized as follows:
(1) 10 mmoles of Ca(OH)² is stirred and equilibrated at 40° C. in 200 ml for 15 minutes.
(2) Subsequently, a calcium ion chelator (citric acid), specifically 2.0-3.3 mmoles is added.
(3) The metal dopant (M^{x+}), was introduced into the apatite lattice at the necessary mole fraction in the form of a soluble salt. (Fe³⁺ was added at 30 mol. % and Nd³⁺ was added at 10 mol. % compared to calcium to produce 3Fe-7Ca hydroxyapatite or 1Nd-9Ca hydroxyapatite).
(4) Lastly, 50 ml containing 6 mmoles of a phosphate (PO₄³⁻) source (KH₂PO₄) is added drop wise to achieve a final volume of 250 ml.
(5) At this time point the pH is about 5 due to addition of the metal salt. Typically 0.5 M NaOH is added dropwise to increase the pH to 8.5. An amorphous calcium phosphate precursor gel is then formed, which is then aged typically for 3 days before the final product is formed.
(6) The final product is a dispersion of nanoparticulate Fe or Nd doped calcium hydroxyl-carbonated apatite in the 10 nm size range, which appears, to the naked eye, as a clear yellow (for Fe doping) and a clear purple (for Nd doping) suspension.

### Example 3

### Characterization of the Nanoparticles

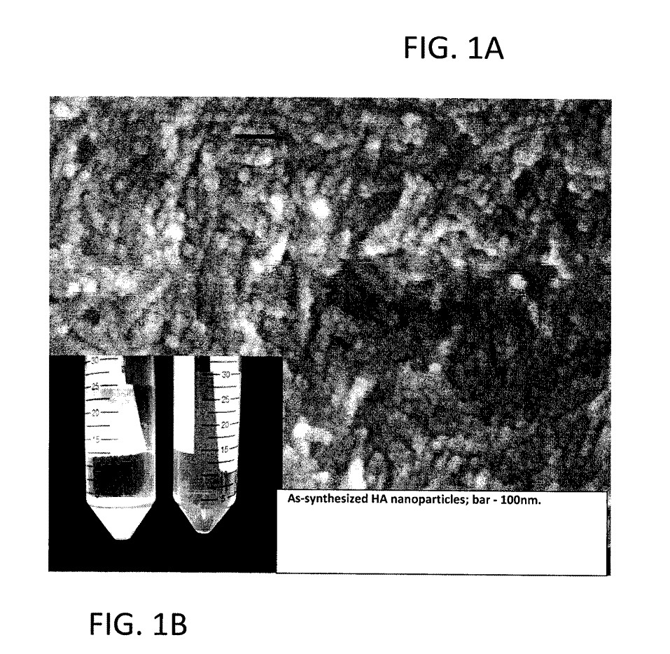

The nanoparticles from Example 1 were examined using field emission scanning electron microscopy (FESEM) and transmission electron microscopy (TEM) and size distribution as determined by these techniques confirmed a 10-20 nm size range for these apatite particles. The particles were more spheroidal (FIG. 1) as opposed to acicular equilibrium shaped particles, attributed to hydroxyapatite. Fourier transform infra-red spectroscopy (FTIR) spectroscopy confirmed that these nanoparticles contained carbonates in the lattice in place of phosphate groups and a blue shifted (C═O) band revealing substantial single bond character corresponding to chemically attached citrate groups on the nanoparticulate surfaces.

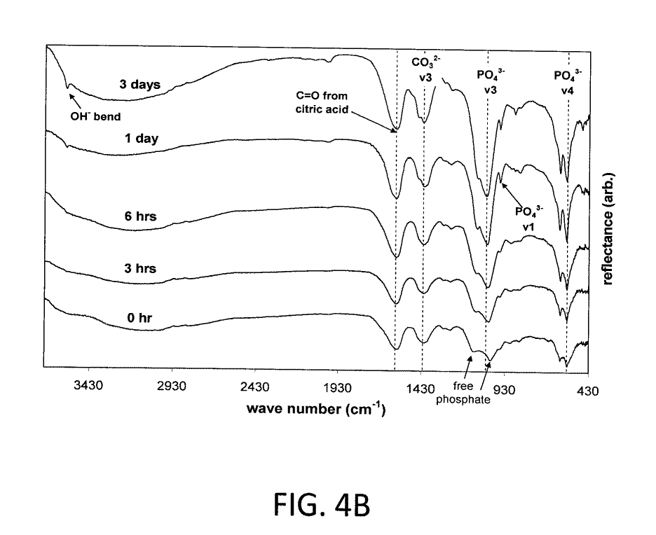

The iron (Fe) and neodymium (Nd) substituted particles (Example 2) were also analyzed similarly and FESEM and FTIR spectroscopy results indicated that the size range and chemical structure of these doped apatite nanoparticles were similar to the undoped samples. The doped nanoparticles exhibited variation in their absorbance profiles (example for Nd—HA is shown in FIG. 2A). Furthermore Fe and Nd-nanoapatites revealed magnetic susceptibility as seen from their ability to assemble, from the colloidal state, over magnetic templates (inset in FIG. 2B for Nd—HA and FIG. 5A and 5B for Fe—HA nanoparticles).

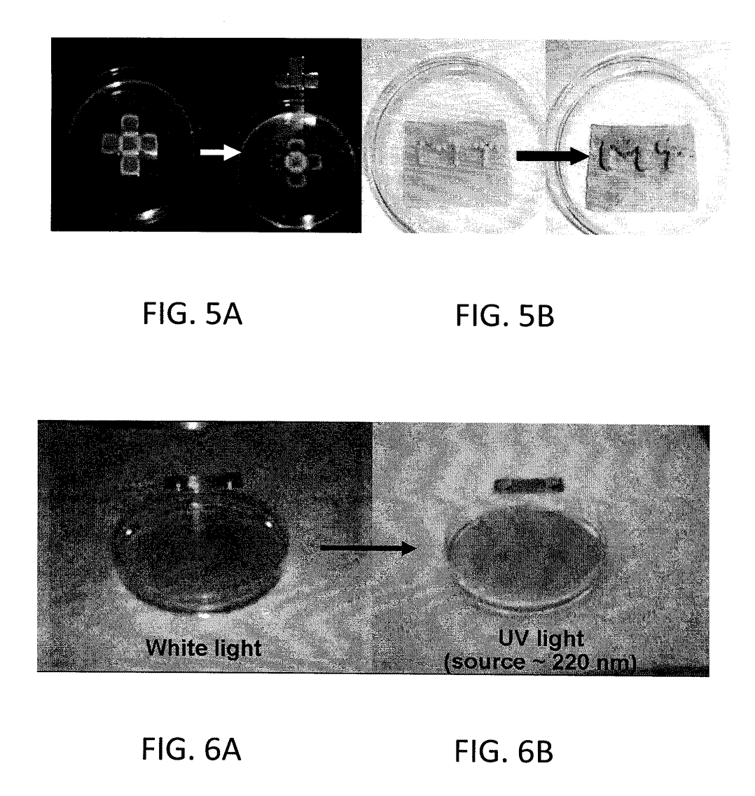

These easy to synthesize particles can be used for detection and treatment-based therapies with higher levels of control greatly impacting health care in the near future. Spheriodal metal-ion doped neodymium (Nd), samarium (Sm), iron (Fe) and copper (Cu) multi-functional apatite nanoparticles (FIG. 2B shows the assembly of Nd-doped magnetic nanoparticles over the circular area delineated by the magnets, which also reveals quantum-dot-like absorbance profiles for 10 and 30 atom % Nd doped nHA) have been synthesized. Other metals that could be used to synthesize the intrinsically multi-functional nanoparticles of the subject invention, include, but are not limited to, gadolinium. The Fe-doped HA nanoparticles, similarly exhibit green luminescence when excited with UV radiation, assemble over high-field magnets even faster and can be easily manipulated and templated into complex shapes (FIG. 6).

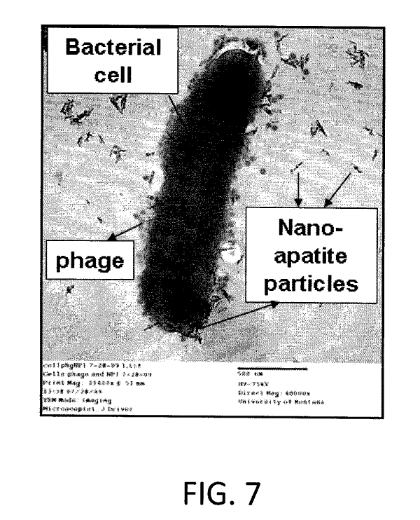

Transmission electron microscopy studies show that the nano-apatite particles of the subject invention interact with bacteria in a specific manner; and accumulated at the ends, as apposed to the sides, of the organism (FIG. 7). Also the presence of nano-apatite particles had an effect on the process of bacteriophage infection. Nano-apatite particles increase the infection of bacteria by bacteriophages. In twelve experiments, an aggregate 13,680 plaques were formed in the presence of nanoparticles, compared to 12,233 plaques that formed without nano-apatite particles, a statistically significant increase of 8.9%. The nano-apatite particles may associate with bacteria so as to reduce the sites available for non-specific interactions between the phage and bacteria, thus reducing the area in which the specific receptors are located thus increasing the effective concentration of the phage binding site, and increasing infection. Therefore nanoparticles can be used to increase/promote bacteriophage infection. Additionally, other potential commercial and medical applications could be developed. Viral vectors have been used in the generation of transgenic animals and plants as well as in some gene therapy trials. These nanoparticles could serve as useful additives to enhance these processes. In addition, phage therapy (using bacteriophages to combat bacterial infections) is a common medical practice in countries of the former Soviet Union. Nanoparticles may make these treatments more effective.

Further, application potential for the subject nanoparticles include, but are not limited to, tunable contrast dyes for MRI, as well as candidates for externally controllable nano-detection devices. Nanoparticles with individual properties, synthesized through various physical and chemical processing routes, are currently available however the combination of intrinsic multi-functionality has not been demonstrated thus far from single or even multiple doping ions. The realization of these properties are also linked to the physiochemical and crystallographic properties of the calcium-hydroxy carbonate-apatite which allow for a substantial metal ion substitution before the apatite structure is compromised. Other than being colloidally stable, achieved through a molecular capping technique during early nucleation and growth, the same surface carboxylate moieties can facilitate the surface functionalization of the nano-apatite particles with other simple linkers (e.g. amine, thiol, etc.) or more complex molecules such as biotin.

It should be understood that the examples and embodiments described herein are for illustrative purposes only and that various modifications or changes in light thereof will be suggested to persons skilled in the art and are to be included within the spirit and purview of this application and the scope of the appended claims.

### REFERENCES

Lebugle, A., Pelle, F., Charvillat, C., Rousselot, I, and Chane-Ching, J. Y., Colloidal and monocrystalline Ln³⁺ doped apatite calcium phosphate as biocompatible fluorescent probes, The Royal Society of Chemistry, 606-608, www.rsc.org/chemcomm, 2006.
Yang, C., Yang, P., Wang, W., Wang, J, Zhang, M, and Lin, J., Solvothermal synthesis and characterization of Ln (Eu³⁺, Tb³⁺) doped hydrozyapatite, Journal of Colloid and Interface Science, 328, (2008) 203-210.
Aissa, A., Debbabi, M., Gruselle, M., Thouvenot, R., Flambard, A., Gredin, P. Beaunier, P. and Tonsuaadu, K., Sorption of tartrate ions to lanthanum (III)-modified calcium fluro-and hydroxyapatite, Journal of Colloid and Interface Science, 330, (2009) 20-28.

1. A hydroxyapatite nanoparticle comprising an intrinsic metal ion, wherein the metal ion causes the nanoparticle to be luminescent and magnetic.

2. The hydroxyapatite nanoparticle of claim 1, wherein said metal ion is iron.

3. The hydroxyapatite nanoparticle of claim 1, wherein said metal ion is neodymium.

4. An intrinsically luminescent and magnetic hydroxyapatite nanoparticle synthesized by a process comprising the steps of :
equilibrating a solution of a calcium ion source, or salt thereof;
adding an appropriate calcium ion chelator;
introducing an effective amount of a metal dopant;
adding dropwise a phosphate source to achieve a final volume;
adjusting the pH of the final volume to from about 8.0 to about 9.0 to form a gel; and
aging the gel to allow the nanoparticles to form,
wherein the molar concentration of the final volume is about 10:6, calcium to phosphate.

5. The nanoparticle of claim 4, wherein said calcium ion chelator is citric acid.

6. The nanoparticle of claim 4, wherein said metal dopant is selected from the group consisting of iron and neodymium.

7. The nanoparticle of claim 6, wherein said metal dopant is iron.

8. The nanoparticle of claim 7, wherein said iron is introduced in from about 5 to about 40 molar percent.

9. The nanoparticle of claim 6, wherein said metal dopant is neodymium.

10. The nanoparticle of claim 9, wherein said neodymium is introduced in from about 5 to about 30 molar percent.

11. The nanoparticle of claim 4, wherein said phosphate source is KH₂PO₄.

12. The nanoparticle of claim 4, wherein said gel is aged about 3 days.

13. An intrinsically luminescent and magnetic hydroxyapatite nanoparticle synthesized by a process comprising the steps of :
equilibrating a solution of Ca(OH)₂;
adding the calcium ion chelator citric acid;
introducing a metal dopant;
adding dropwise a phosphate source to achieve a final volume;
adjusting the pH of the final volume to about 8.5 to form a gel; and
aging the gel about 3 days to allow the nanoparticles to form,
wherein the molar concentration of the final volume is about 10:6, calcium to phosphate.

14. The nanoparticle of claim 11, wherein said metal dopant is selected from the group consisting of iron and neodymium.

15. The nanoparticle of claim 11, wherein said metal dopant is iron.

16. The nanoparticle of claim 13, wherein said iron is introduced in from about 5 to about 40 molar percent.

17. The nanoparticle of claim 11, wherein said metal dopant is neodymium.

18. The nanoparticle of claim 15, wherein said neodymium is introduced in from about 5 to about 30 molar percent.
